(19) United States
(12) Patent Application Publication
(10) Pub. No.: US 2026/0214434 A1
(43) Pub. Date: Jul. 23, 2026

(54) COMMUNICATION CONTROL METHOD AND USER EQUIPMENT

(71) Applicant: KYOCERA Corporation, Kyoto (JP)

(72) Inventor: Mitsutaka HATA, Yokohama-shi (JP)

(73) Assignee: KYOCERA Corporation, Kyoto (JP)

(21) Appl. No.: 19/631,183

(22) Filed: Mar. 27, 2026

Related U.S. Application Data
(63) Continuation of application No. PCT/JP2024/034579, filed on Sep. 27, 2024.

(30) Foreign Application Priority Data
Sep. 28, 2023 (JP) 2023-168547

(51) Int. Cl. H04W 8/24; H04W 76/27

(52) U.S. Cl. CPC H04W 8/24; H04W 76/27

(57) ABSTRACT

In an aspect, a communication control method is a communication control method in a mobile communication system. The communication control method includes transmitting, by a network apparatus to a user equipment in an RRC idle state or an RRC inactive state, AI/ML model use information indicating an AI/ML model to be used at the user equipment when congestion occurs. The communication control method includes transmitting, by the user equipment to the network apparatus, AI/ML model holding information indicating the AI/ML model held by the user equipment when the user equipment is in an RRC connected state in response to reception of the AI/ML model use information.

### RELATED APPLICATIONS

The present application is a continuation based on PCT Application No. PCT/JP2024/034579, filed on Sep. 27, 2024, which claims the benefit of Japanese Patent Application No. 2023-168547 filed on Sep. 28, 2023. The content of which is incorporated by reference herein in their entirety.

### TECHNICAL FIELD

The present disclosure relates to a communication control method and a user equipment.

### BACKGROUND

In recent years, the Third Generation Partnership Project (3GPP) (trade name), which is a standardization project for mobile communication systems, has studied applying artificial intelligence (AI) technology, particularly, machine learning (ML) technology, to wireless communication (air interface) in the mobile communication systems.

### CITATION LIST

### Non-Patent Literature

Non-Patent Document 1: RP-213599, “New SI: Study on Artificial Intelligence (AI)/Machine Learning (ML) for NR Air Interface”

### SUMMARY

A communication control method according to a first aspect is a communication control method in a mobile communication system. The communication control method includes transmitting, by a network apparatus to a user equipment in an RRC idle state or an RRC inactive state, AI/ML model use information indicating an AI/ML model to be used at a user equipment when congestion occurs. The communication control method includes transmitting, by the user equipment to the network apparatus, AI/ML model holding information indicating the AI/ML model held by the user equipment when the user equipment is in an RRC connected state in response to reception of the AI/ML model use information.

In a second aspect, a user equipment is used in a mobile communication system. The user equipment includes a receiver configured to, when the user equipment is in an RRC idle state or an RRC inactive state, receive AI/ML model use information indicating an AI/ML model to be used when congestion occurs from a network apparatus. The user equipment includes a transmitter configured to transmit, to the network apparatus, AI/ML model holding information indicating an AI/ML model held by the user equipment when the user equipment is in an RRC connected state in response to reception of the AI/ML model use information.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an operation example according to a first embodiment.

FIG. 10 is a diagram illustrating an arrangement example of functional blocks of the AI/ML technology according to the first embodiment.

FIG. 11 is a diagram illustrating an arrangement example of functional blocks of the AI/ML technology according to the first embodiment.

FIG. 12 is a diagram illustrating an arrangement example of functional blocks of the AI/ML technology according to the first embodiment.

FIG. 13 is a diagram illustrating an operation example according to the first embodiment.

FIG. 14 is a diagram illustrating an example of a configuration message according to the first embodiment.

FIG. 15 is a diagram illustrating a configuration example of functional blocks of an AI/ML technology according to the first embodiment.

FIG. 16 is a diagram illustrating an example of an operation example according to the first embodiment.

### DESCRIPTION OF EMBODIMENTS

An objective of the present disclosure is to enable a network apparatus to appropriately ascertain an AI/ML model held by user equipment.

### First Embodiment

A mobile communication system according to a first embodiment will be described with reference to the drawings. In the description of the drawings, the same or similar parts are denoted by the same or similar reference signs.

### Configuration of Mobile Communication System

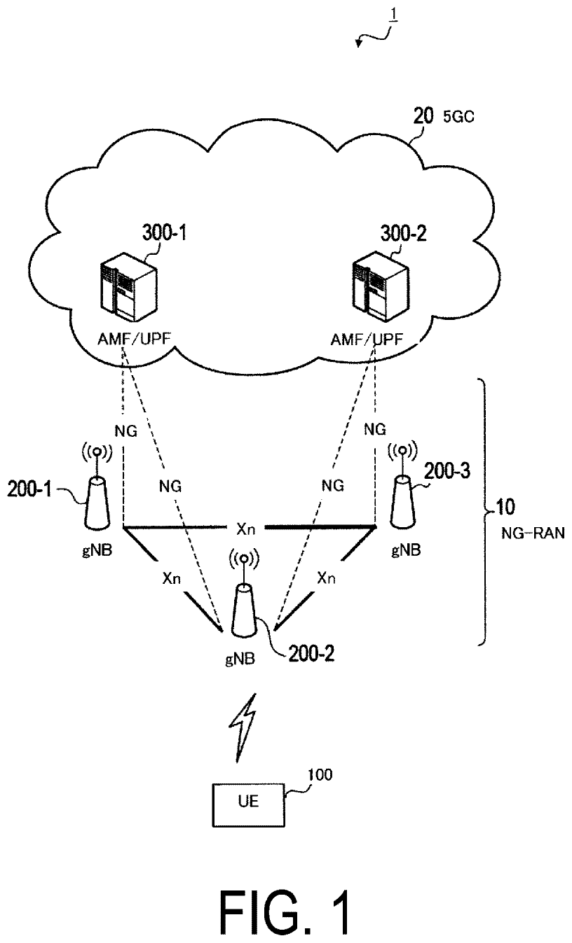

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 may be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5 GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

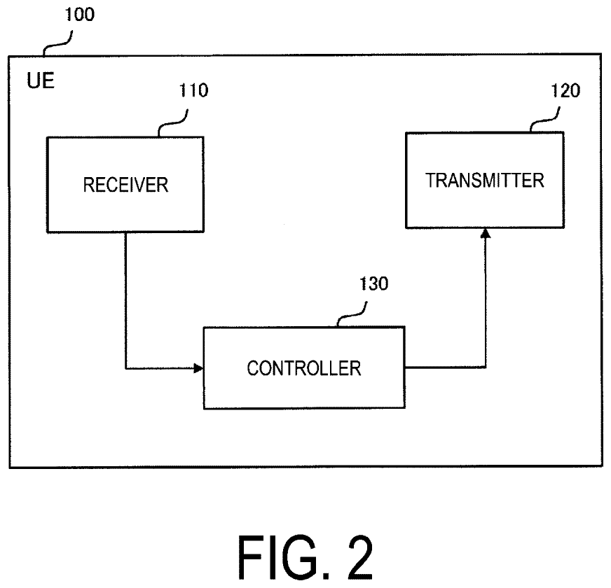

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a receiver. The receiver converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

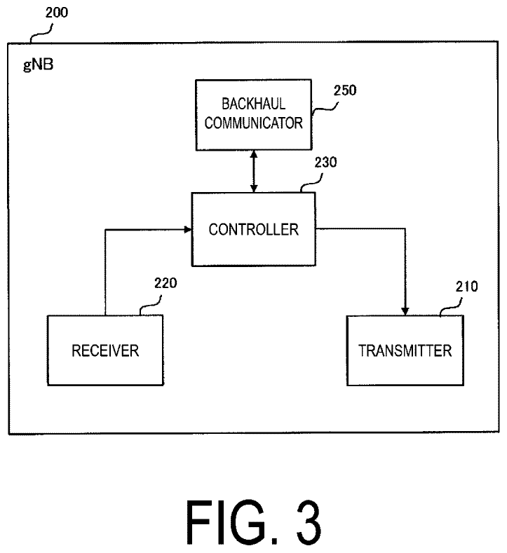

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The receiver converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

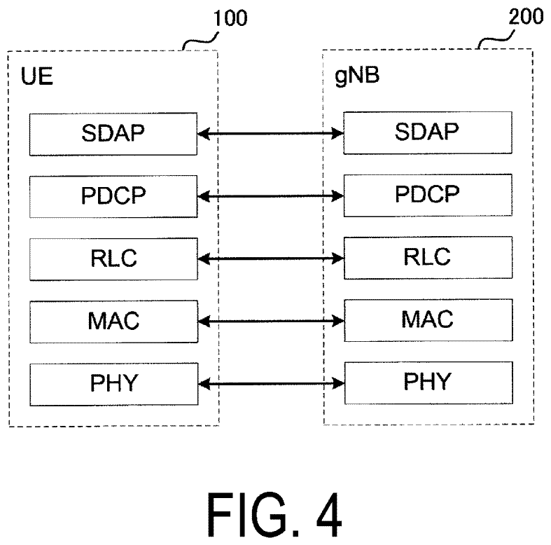

FIG. 4 is a diagram illustrating a configuration example of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

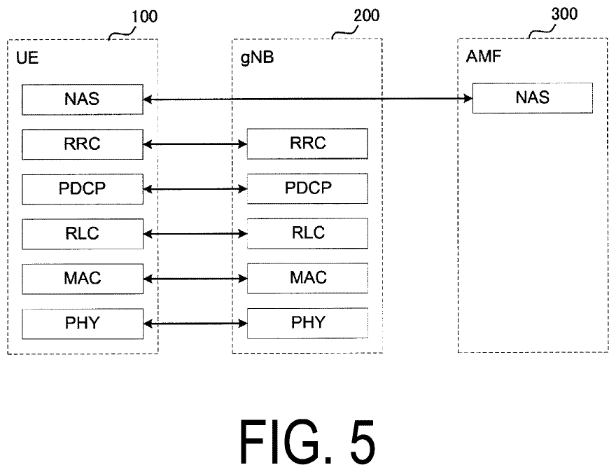

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer other than the protocol of the radio interface. A layer lower than the NAS is referred to as an Access Stratum (AS).

### AI/ML Technology

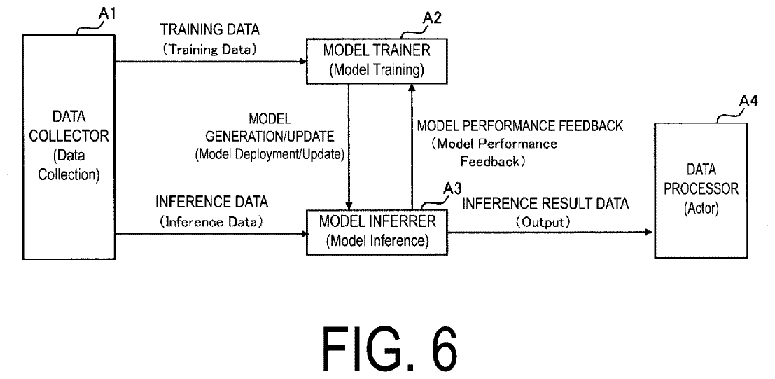

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to the process of collecting data at a network node, a management entity, or the UE 100, for example, to train AI/ML models, perform data analysis, and inference. Based on the data collected by the data collector A1, the training of the AI/ML model and the inference of the AI/ML model in the subsequent stage are performed. The “AI/ML model” is, for example, a data-driven algorithm to which an AI/ML technology is applied to generate a series of outputs based on a series of inputs. Hereinafter, the “model” and the “AI/ML model” may be used interchangeably.

The model trainer A2 performs model training. Specifically, the model trainer A2 optimizes parameters of the training model through machine learning using the training data, and derives (or generates, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although the supervised learning will be described hereinafter, unsupervised learning may be applied as the machine learning. The reinforcement learning may be applied as the machine learning. In this way, the process of training an AI/ML model (by training the relationship between input and output) in a data-driven manner and acquiring a trained AI/ML model is called, for example, AI/ML model training. Hereinafter, the “AI/ML model training” may be referred to as a “model training”. The trained AI/ML model may be referred to as a “trained model”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2. This process of using a trained AI/ML model to generate a series of outputs based on a series of inputs is called AI/ML model inference. Hereinafter, the “AI/ML model inference” may be referred to as “model inference”.

The data processor A4 receives the inference result data and performs processing that utilizes the inference result data.

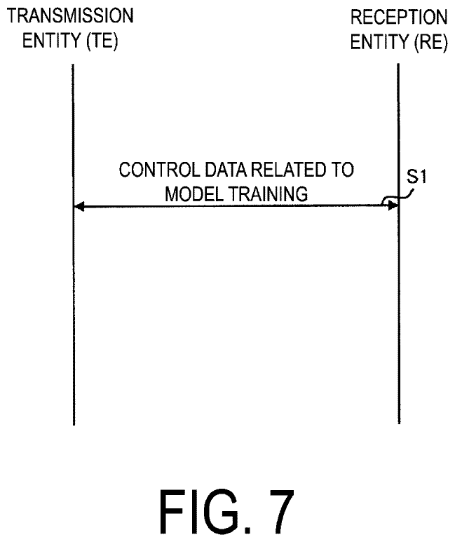

FIG. 7 is a diagram illustrating an operation example in the AI/ML technology according to the first embodiment.

A transmission entity TE is, for example, an entity in which machine learning is performed. The transmission entity TE may derive a trained model by performing machine learning. The transmission entity TE uses the trained model to generate inference result data as an inference result. The transmission entity TE can transmit the inference result data to a reception entity RE.

The reception entity RE is, for example, an entity in which no machine learning is performed. The reception entity RE can receive the inference result data transmitted from the transmission entity TE. The reception entity RE performs various processing operations by using the inference result data. The reception entity RE may derive a trained model by performing machine learning. In this case, the reception entity RE transmits the derived trained model to the transmission entity TE.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 7, in step S1, the transmission entity TE transmits to and receives from the reception entity RE control data related to the AI/ML technology. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) Feedback enhancement”
(1.2) “Beam management”
(1.3) “Positioning accuracy enhancement”
   Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

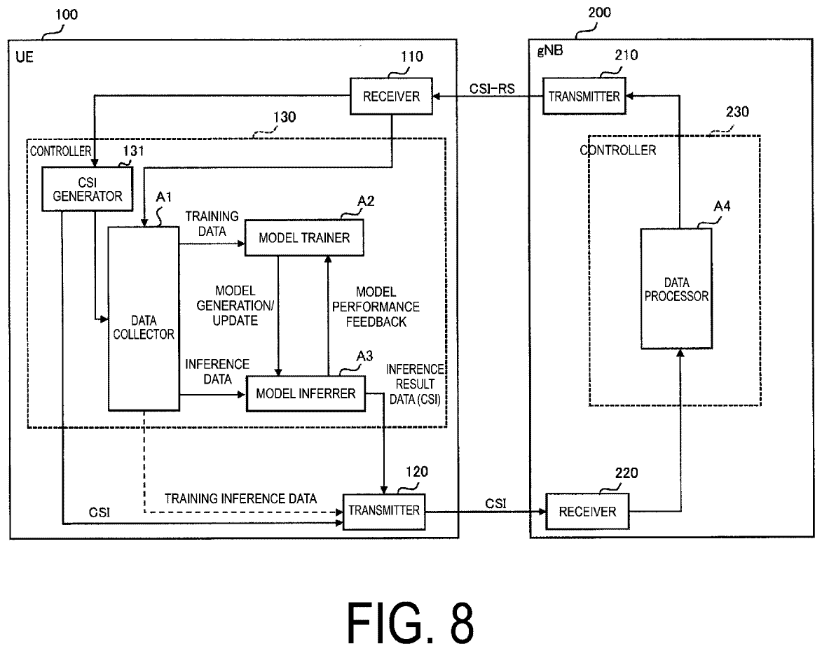

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal and CSI. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

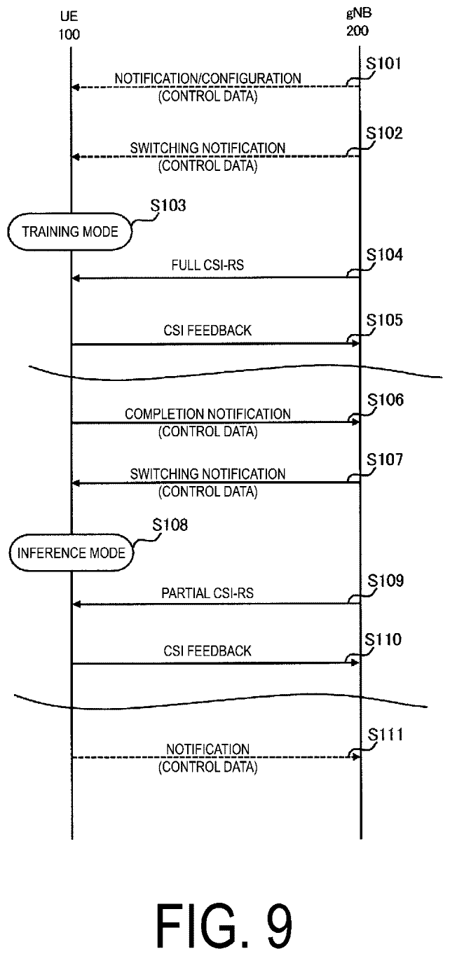

FIG. 9 is a diagram illustrating an operation example in the “CSI feedback enhancement” according to the first embodiment.

As illustrated in FIG. 9, in step S101, the gNB 200 may notify the UE 100 of or configure for the UE 100, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back), to the gNB 200 as inference result data, the CSI, which is an inference result. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the example illustrated in FIG. 9, an example in which the training data is “(full) CSI-RS” and “CSI”, and the inference data is “(partial) CSI-RS” has been described. Hereinafter, the training data and/or the inference data may be referred to as a “dataset”.

In the “CSI feedback enhancement”, in addition to the “CSI-RS” and the “CSI”, for example, the following data and/or information may be used as the dataset.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)
   What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits, to the UE 100 as the control data, the data type information used as a dataset. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

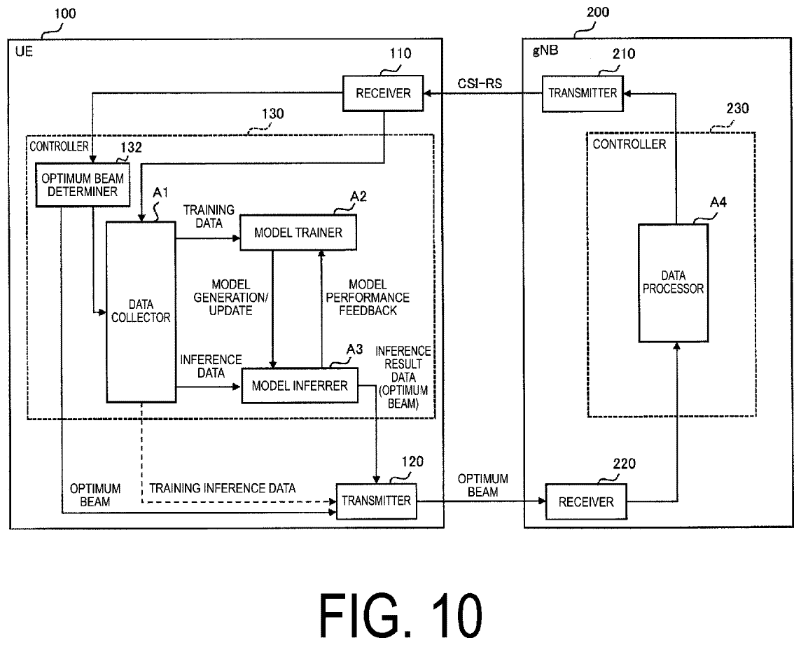

FIG. 10 is a diagram illustrating an arrangement example of each of the functional blocks in the “beam management”. In the example of the “beam management” illustrated in FIG. 10, the controller 130 of the UE 100 includes the data collector A1, the model trainer A2, and the model inferrer A3. On the other hand, the controller 230 of the gNB 200 includes the data processor A4. In other words, FIG. 10 illustrates an example in which the UE 100 performs model training and model inference. FIG. 10 illustrates the example in which the transmission entity TE is the UE 100 and the reception entity RE is the gNB 200.

As illustrated in FIG. 10, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 9.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, the following data and/or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)
   The UE 100 may transmit capability information as the control data to the gNB 200, the capability information indicating which type of input data the UE 100 can handle in the machine learning. The capability information may include any information or data from (Y1) to (Y6), or may include any information or data from (Y1) to (Y6), separate from training data and inference data. The gNB 200 may transmit, to the UE 100 as the control data, the data type information used as a dataset. The data type information may include, for example, any of the data or information indicated in (Y1) to (Y6). Aside from the training data and the inference data, the data type information may include any information or data from among (Y1) to (Y6).

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

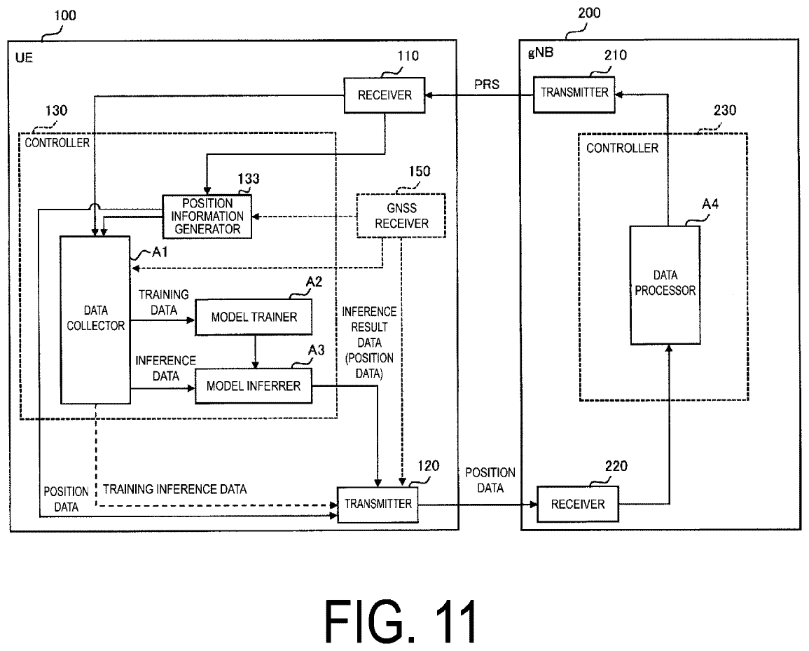

FIG. 11 is a diagram illustrating an arrangement example of each of the functional blocks in the “positioning accuracy enhancement”. In the example of the “positioning accuracy enhancement” illustrated in FIG. 11, the controller 130 of the UE 100 includes the data collector A1, the model trainer A2, and the model inferrer A3. On the other hand, the controller 230 of the gNB 200 includes the data processor A4. In other words, FIG. 11 illustrates an example in which the UE 100 performs model training and model inference. FIG. 11 illustrates the example in which the transmission entity TE is the UE 100 and the reception entity RE is the gNB 200.

As illustrated in FIG. 11, the UE 100 includes a position information generator 133. The UE 100 may include a Global Navigation Satellite System (GNSS) receiver 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS receiver 150 and generate the position data of the UE 100 based on the GNSS signal.

Note that, as with the full CSI-RS, the gNB 200 transmits the full PRS using a predetermined amount of first resources (for example, all antenna ports or a predetermined amount of time frequency resources). As with the partial CSI-RS, the gNB 200 transmits the partial PRS by using the second resources (for example, half the antenna ports in the antenna panel, or half the predetermined amount of time-frequency resources) in a smaller amount than the first resources.

The full GNSS signal may be a GNSS signal temporally continuously received by the GNSS receiver 150. The partial GNSS signal may be a GNSS signal intermittently received by the GNSS receiver 150. In other words, a predetermined amount of first resources may be used for the full GNSS signal, and the second resources the amount of which is smaller than that of the first resources may be used for the partial GNSS signal.

An operation example in the “positioning accuracy enhancement” can be implemented by replacing the “full CSI-RS” with the “full PRS”, the “partial CSI-RS” with the “partial PRS”, and the “CSI feedback” with the “position data” in FIG. 9.

In the training mode (step S103), the position information generator 133 generates the position data of the UE 100 based on the full PRS received from the gNB 200. The position information generator 133 may receive a full GNSS signal received by the GNSS receiver 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS receiver 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, the following data and/or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (trade name), or Bluetooth (trade name)
(Z7) Moving speed of the UE 100 (the moving speed may be measured by the GNSS receiver 150. The moving speed may be measured by a speed sensor in the UE 100)
   The UE 100 may transmit capability information as the control data to the gNB 200, the capability information indicating which type of input data the UE 100 can handle in the machine learning. The capability information may include any information or data from (Z1) to (Z7), or may include any information or data from (Z1) to (Z7), separate from training data and inference data. The gNB 200 may transmit, to the UE 100 as the control data, the data type information used as a dataset. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described.

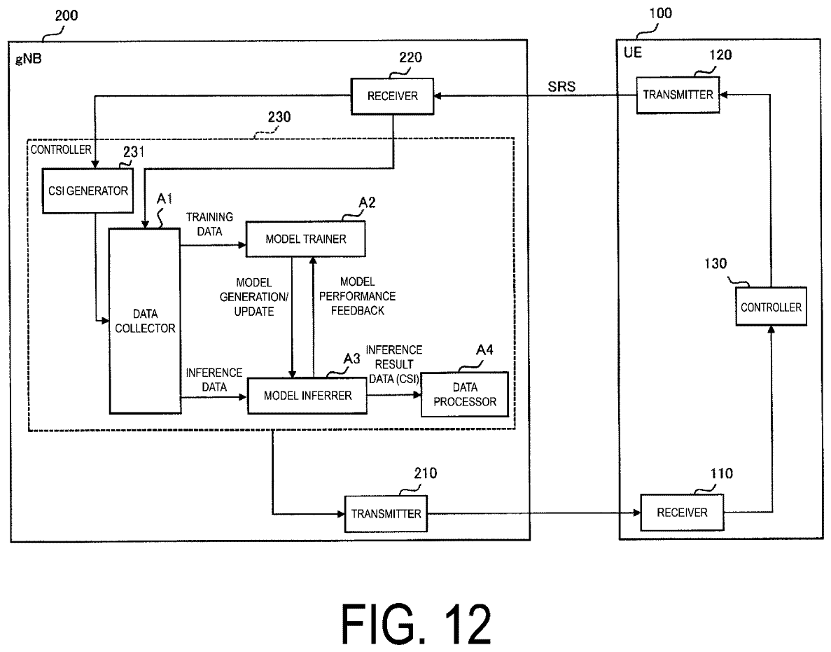

FIG. 12 is a diagram illustrating another arrangement example of the “CSI feedback enhancement” according to the first embodiment. FIG. 12 illustrates an example in which the gNB 200 includes the data collector A1, the model trainer A2, the model inferrer A3, and the data processor A4. In other words, FIG. 12 illustrates an example in which the gNB 200 performs model training and model inference. FIG. 12 illustrates an example in which the transmission entity TE is the gNB 200 and the reception entity RE is the UE 100.

FIG. 12 illustrates an example in which the AI/ML technology is introduced into CSI estimation performed by the gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

### (1.5) Model Transfer Example

In (1.1) to (1.4), the arrangement example of the functional blocks of the AI/ML technology has been described. Model transfer will be described below. The model to be transferred may be a trained model used in the model inference. The model may be an untrained model used in the model training (or a model being trained).

### (1.5.1) First Operation Pattern Relating to Model Transfer

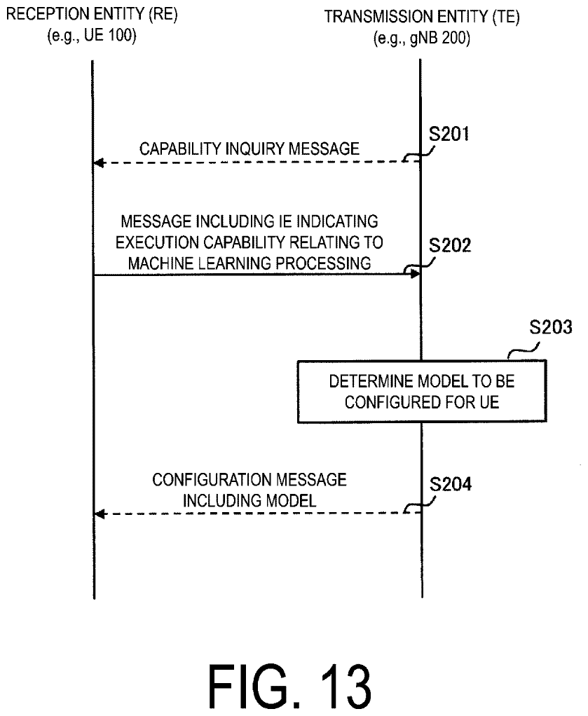

FIG. 13 is a diagram illustrating an operation example of a first operation pattern relating to model transfer according to the first embodiment. In the example illustrated in FIG. 13, the reception entity RE is mainly described as the UE 100. However, the reception entity RE may be the gNB 200 or the AMF 300. In the example illustrated in FIG. 13, the transmission entity TE is mainly described as the gNB 200. However, the transmission entity TE may be the UE 100 or the AMF 300.

As illustrated in FIG. 13, in step S201, the gNB 200 transmits, to the UE 100, a capability inquiry message for requesting transmission of a message including an information element (IE) indicating the execution capability relating to machine learning processing. The UE 100 receives the capability inquiry message. However, the gNB 200 may transmit the capability inquiry message when performing the machine learning processing (when determining to perform the machine learning process).

In step S202, the UE 100 transmits, to the gNB 200, the message including an information element indicating an execution capability relating to the machine learning processing (an execution environment for the machine learning processing, from another viewpoint). The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. Alternatively, when a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be, specifically, an information element indicating whether a deep neural network model can be supported or an information element indicating a time (or a response time) required for execution of the inference processing.

Alternatively, the information element indicating the execution capability relating to the machine learning processing may be an information element indicating the execution capability of the learning processing (model training). The information element indicating the execution capability of the learning processing may be specifically an information element indicating the number of simultaneous executions of the learning processing or an information element indicating a processing capacity of the learning processing.

In step S203, the gNB 200 determines a model to be configured (deployed) for the UE 100 based on the information element included in the message received in step S202.

In step S204, the gNB 200 transmits, to the UE 100, a message including the model determined in step S203. The UE 100 receives the message and performs the machine learning processing (i.e., model training processing and/or model inference processing) using the model included in the message. A specific example of step S204 will be described next in a second operation pattern.

### (1.5.2) Second Operation Pattern Relating to Model Transfer

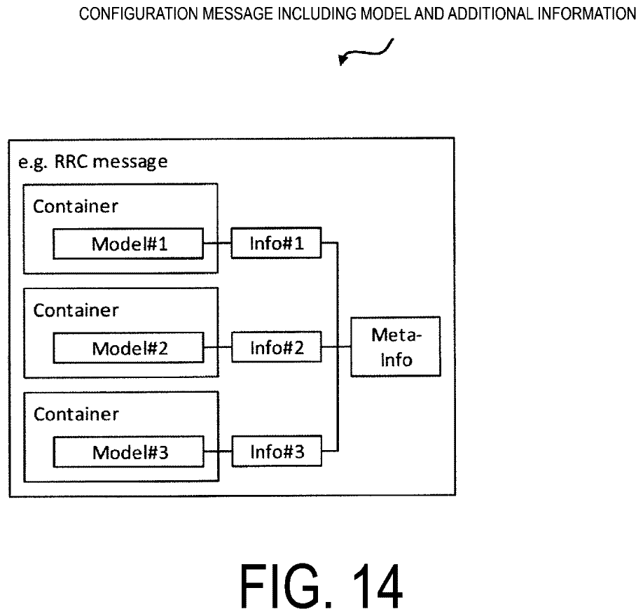

FIG. 14 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 14, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (1.6) Configuration Example of Functional Blocks

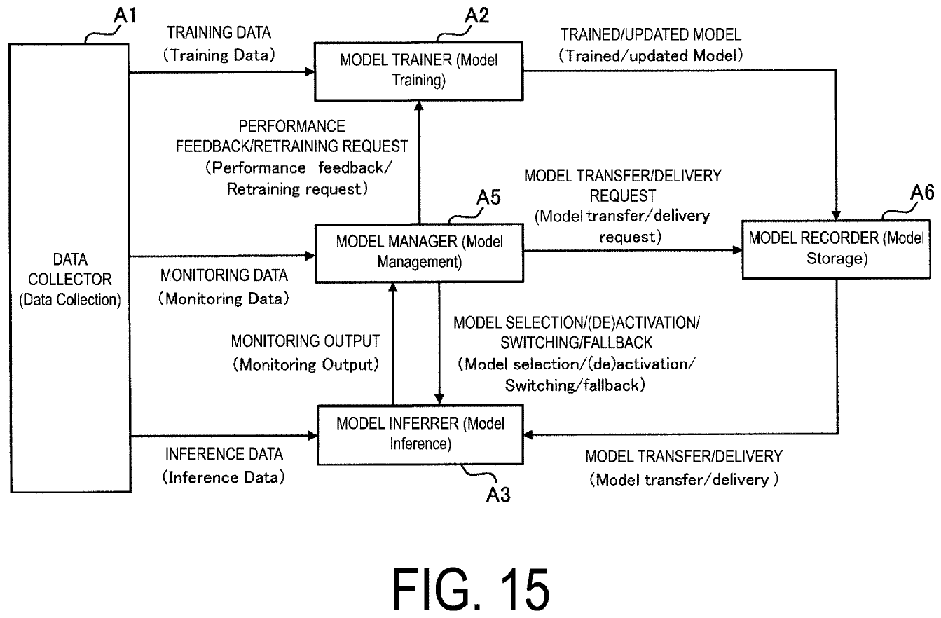

The functional blocks of the AI for wireless communication have been described with reference to FIG. 6. Currently, the 3GPP has studied a block diagram illustrated in FIG. 15 for functional blocks of AI for wireless communication.

FIG. 15 is a diagram illustrating a configuration example of functional blocks according to the first embodiment. The functional block diagram illustrated in FIG. 15 further includes a model manager A5 and a model recorder A6, as compared with the functional block diagram illustrated in FIG. 6.

The model manager A5 manages the AI/ML model. For example, the model manager A5 requests the model trainer A2 to re-train the training model, or requests the model recorder A6 to transfer the model. As illustrated in FIG. 15, the AI/ML model that has been trained in the re-training may be referred to as an updated model. For example, the model manager A5 instructs (or requests) the model inferrer A3 to select a model, (de)activate a model, switch a model, and/or fall back. The model manager A5 may evaluate the performance of the trained models using the monitoring data acquired from the data collector A1 and the monitoring output acquired from the model inferrer A3, and request re-training or instruct switching of the models based on the evaluation results.

The model recorder A6 functions as a reference point in the functional blocks. Therefore, the model recorder A6 does not necessarily have to record the trained model or the updated model in the recording media.

Note that how the functional blocks illustrated in FIG. 15 are arranged in each use case is under discussion in the 3GPP.

In the following, the AI/ML model to be trained may be referred to as a “training model” and the AI/ML model after training may be referred to as a “trained model”. Data for inference may be referred to as inference data, and data for training may be referred to as training data. When the AI/ML model in the middle of model training and the trained AI/ML model are not distinguished from each other, they may be simply referred to as AI/ML models. The “AI/ML model” is, for example, a data-driven algorithm to which an AI/ML technology is used to obtain a series of outputs based on a series of inputs, as described above.

### Communication Control Method According to First Embodiment

A communication control method according to the first embodiment will be described.

Currently, the 3GPP has discussed transfer (or delivery) of the AI/ML model. In particular, an agreement has been made on reactive model transfer/delivery (which may be referred to as a “reactive model transfer” in the following). The reactive model transfer refers to a technique of downloading an AI/ML model when the model is needed due to a scenario, a configuration, or a change of location. For example, the UE 100 performs a handover (i.e., change of location) to the target cell and receives a new AI/ML model from the target cell when the AI/ML model is not available in the target cell. Such a case is expected to corresponds to the reactive model transfer.

In the 3GPP, in addition to the reactive model transfer, a proactive model transfer/delivery (which may be referred to as a “proactive model transfer” below) will be discussed. The proactive model transfer refers to a technique in which, for example, an AI/ML model is downloaded in advance, and model switching is performed when a change occurs in a scenario, a configuration, or a location. For example, the technique includes pre-downloading, by the UE 100, an AI/ML model from a serving cell, and after handover to the target cell, switching to the downloaded AI/ML model (from the previously used AI/ML model). The proactive model transfer allows immediate use of the (pre-downloaded) AI/ML model, for example, since the UE 100 has no need to wait for the AI/ML model to be downloaded after a change in location.

In the first embodiment, attention is paid to the proactive model transfer. For example, if the network apparatus can ascertain what kind of AI/ML model the UE 100 is holding, the proactive model transfer can be appropriately executed. That is, the network apparatus may transmit an AI/ML model that the UE 100 is not holding to the UE 100 by using proactive model transfer, or may not transmit, to the UE 100, the AI/ML model that the UE 100 is holding, for example. In particular, when the UE 100 is in the RRC idle state or the RRC inactive state, the gNB 200 cannot communicate with the UE 100 using an RRC message, and thus appropriately ascertaining the AI/ML model that the UE 100 is holding is difficult. When the UE 100 is in the RRC idle state or the RRC inactive state, the network apparatus has difficulty transmitting the AI/ML model to the UE 100 through proactive model transfer.

The first embodiment aims to enable the network apparatus to appropriately ascertain the AI/ML model that the UE 100 is holding.

To this end, in the first embodiment, first, the network apparatus transmits, to user equipment (for example, the UE 100) that is in the RRC idle state or the RRC inactive state, AI/ML model use information indicating the AI/ML model to be used by the user equipment when congestion occurs. Second, the user equipment transmits AI/ML model holding information indicating the AI/ML model held by the user equipment to the network apparatus in the RRC connected state in response to reception of the AI/ML model use information.

In this way, the network apparatus can receive the AI/ML model holding information, and thus can appropriately ascertain the AI/ML model that the UE 100 is holding. This also enables the network apparatus to appropriately execute proactive model transfer.

### Operation Example According to First Embodiment

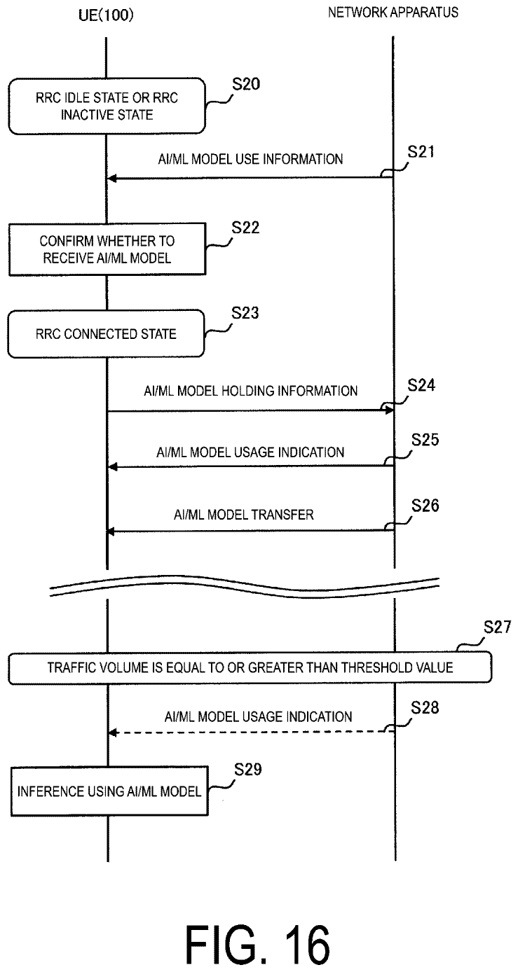

FIG. 16 is a diagram illustrating an operation example according to the first embodiment. The network apparatus may be the gNB 200, a core network apparatus, or an over-the-top (OTT) server in FIG. 16. The core network apparatus may be, for example, the AMF 300. The core network apparatus may be another core network apparatus such as SMF.

In step S20, the UE 100 is in an RRC idle state or an RRC inactive state, as shown in FIG. 16.

In step S21, the network apparatus transmits AI/ML model use information to the UE 100. The AI/ML model use information indicates an AI/ML model to be used by the UE 100 when congestion occurs.

First, the AI/ML model use information may include at least any of identification information (or model ID) of a trained AI/ML model to be used by the UE 100 when congestion occurs and a function name of the trained AI/ML model. The function name may be represented by a use case to which the AI/ML technology is applied, such as any of “CSI feedback enhancement”, “beam management”, and “position accuracy enhancement”. Alternatively, the AI/ML model use information may include the use start day and time of the trained AI/ML model. Alternatively, the AI/ML model use information may include any of mandatory download and optional download for downloading the trained AI/ML model to the UE 100. That is, the AI/ML model use information may include information indicating whether the network apparatus performs mandatory download of the trained AI/ML model or optional download of the trained AI/ML model. The arbitrary downloading is that, for example, the network apparatus waits for a request from the UE 100 to download the trained AI/ML model. Alternatively, the AI/ML model use information may include a transmission request for transmitting the cell ID of the cell on which the UE 100 is camping at regular time intervals. The AI/ML model use information may include the time (e.g., every one hour, etc.). By causing UE 100 to report the cell on which UE 100 is camping, the network apparatus can ascertain which cell the UE 100 is currently being camped, and can appropriately transmit the trained AI/ML model to the UE 100 via the cell.

Second, the AI/ML model use information may be included and broadcast in a system information block (SIB). Alternatively, the AI/ML model use information may be included in a paging message and transmitted to the UE 100. For example, the transmitter 120 of the gNB 200 may broadcast the SIB including the AI/ML model use information, or may transmit a paging message including the AI/ML model use information (for example, a paging message by RAN-initiated RAN paging) to the UE 100. Alternatively, the transmitter of the AMF may transmit a paging message (for example, a paging message by CN-initiated CN paging) including the AI/ML use information to the UE 100 as a NAS message. Alternatively, the transmitter of the OTT server may transmit a message of a predetermined protocol including the AI/ML model use information to the UE 100. The UE 100 receives the AI/ML model use information. For example, the receiver of the UE 100 receives a message including the AI/ML model use information.

In step S22, the UE 100 confirms whether to receive the trained AI/ML model in response to reception of the AI/ML model use information. For example, the controller 130 of the UE 100 may confirm whether or not the trained AI/ML model can be received according to the availability of the memory. Alternatively, the controller 130 may cause the user to confirm whether or not to receive the trained AI/ML model via a user interface (UI) displayed on the display. Description will be provided below on the assumption that the UE 100 has confirmed that the trained AI/ML model specified in the AI/ML model use information can be received.

In step S23, the UE 100 transitions to the RRC connected state.

In step S24, the UE 100 transmits the AI/ML model holding information to the network apparatus. The AI/ML model holding information indicates the trained AI/ML model held by the UE 100. Note that the AI/ML model holding information may be used when the network apparatus wants to ascertain the trained AI/ML model held by the UE 100, regardless of the operation (FIG. 16) during congestion. In this case, the AI/ML model holding information may be used regardless of whether the trained AI/ML model is transmitted through a proactive model operation or the trained AI/ML model is transmitted through a reactive model operation.

First, the AI/ML model holding information may include identification information of the trained AI/ML model held by the UE 100. Alternatively, the AI/ML model holding information may include the function name of the trained AI/ML model.

Second, the AI/ML model holding information may be transmitted to the gNB 200 using an RRC message. The RRC message may be a UE Capability Information (UECapabilityInformation) message, a UE Assistance Information (UEAssistanceInformation) message, a Measurement Report (MeasurementReport), or the like. Alternatively, the UE 100 may transmit, to the AMF 300, a NAS message including the AI/ML model holding information. Alternatively, the UE 100 may transmit a message of a predetermined protocol including the AI/ML model holding information to the OTT server. The transmitter 120 of the UE 100 may perform the transmission of the AI/ML model holding information.

Third, when the AI/ML model use information includes a transmission request for transmitting the cell ID of the cell on which the UE 100 is camping at regular time intervals, the UE 100 transmits the cell ID of the cell on which the UE is camped to the network apparatus at regular time intervals in response to the transmission request. The UE 100 may include the cell ID in the AI/ML model holding information and transmit the AI/ML model holding information to the network apparatus. The UE 100 may include and transmit the cell ID in a message different from the AI/ML model holding information. The separate message may be an RRC message, a NAS message, and a message of a predetermined protocol, depending on the type of the network apparatus.

Note that the UE 100 may transmit the AI/ML model holding information to the network apparatus at regular time intervals. The network apparatus can ascertain the trained AI/ML model held by the UE 100 at regular time intervals, and can appropriately manage the trained AI/ML model.

The network apparatus receives the AI/ML model holding information. For example, the receiver of the network apparatus receives a message including the AI/ML model holding information.

In step S25, the network apparatus transmits an AI/ML model usage indication to the UE 100 in response to the reception of the AI/ML model holding information. The usage indication may be a usage indication for indicating to the UE 100 to use the trained AI/ML model when congestion occurs. The usage indication may include identification information (e.g., model ID) of the trained AI/ML model to be used. The trained AI/ML model to be used is, for example, a trained AI/ML model specified by the AI/ML model use information (step S21). For example, the transmitter of the network apparatus transmits a message including the usage indication to the UE 100. The message may be an RRC message, a NAS message, and a message of a predetermined protocol depending on the type of the network apparatus.

First, for a UE-sided model, the network apparatus confirms whether the UE 100 is holding the AI/ML model that is a target of the usage indication. The UE-sided model is, for example, a model in which the UE 100 performs inference using a trained AI/ML model. On the other hand, a model in which the network apparatus performs inference using the trained AI/ML model may be referred to as a network-sided model. The controller 130 of the UE 100 confirms whether the UE 100 is holding the trained AI/ML model that is a target of the usage indication based on the AI/ML model holding information (step S24).

If the network apparatus confirms that the UE 100 is not holding the trained AI/ML model that is a target of the usage indication, the network apparatus transmits the trained AI/ML model to the UE 100 (that is, performs “model transfer”) in step S26. For example, the transmitter of the network apparatus transmits a message including the trained AI/ML model to the UE 100. The message may be an RRC message, a NAS message, and a message of a predetermined protocol depending on the type of the network apparatus.

As described above, in the first embodiment, “model transfer” of the trained AI/ML model is performed before congestion occurs. The “model transfer” can be considered to correspond to the “proactive model transfer” described above.

Second, in the case of a network-sided model, a network apparatus indicates collection of inference data and transmission of the inference data to the network apparatus (Data Collection) as a usage indication (step S25) for the trained AI/ML model.

Note that, in the network-sided model, the UE 100 may hold a target trained AI/ML model. In this case, the network apparatus may indicate to the UE 100 to transfer the trained AI/ML model together with the usage indication for the trained AI/ML model (step S25). The transmitter of the network apparatus transmits a message including the indication for transfer of the trained AI/ML model to the UE 100. In response to the reception of the message by the receiver 110 of the UE 100, the transmitter 120 of the UE 100 transmits the trained AI/ML model (a message including the trained AI/ML model) to the network apparatus. In this case, a “model transfer” of the trained model is performed as well before congestion occurs. The “model transfer” can be considered to correspond to a “proactive model transfer”. Both the message transmitted by the network apparatus and the message transmitted by the UE 100 may be an RRC message, a NAS message, or a message of a predetermined protocol depending on the type of the network apparatus.

In step S27, the traffic volume on the data communication path of the UE 100 is equal to or greater than a threshold. That is, congestion occurs in the communication path.

In step S28, the network apparatus may transmit a usage indication for the trained AI/ML model to the UE 100. Since the network apparatus has transmitted the usage indication for the AI/ML model in step S25, step S28 need not be performed.

In the case of the UE-sided model, in step S29, the UE 100 performs inference using the trained AI/ML model received in step S26 according to the usage indication. In the case of the network-sided model, the UE 100 collects inference data for the trained AI/ML model to be used by the network apparatus and transmits the collected inference data to the network apparatus, instead of performing step S29. The inference data may also be transmitted using an RRC message, a NAS message, or a message of a predetermined protocol, depending on the type of the network apparatus.

### Another Operation Example 1 According to First Embodiment

In the first embodiment, the UE-sided model has been mainly described. The first embodiment is also applicable to a two-sided model. The two-sided model is, for example, a model in which inference using a trained AI/ML model is performed in both the UE 100 and the network apparatus. The two-sided model is, for example, as described below.

That is, the UE 100 uses the trained AI/ML model to infer (or output) a punctured CSI-RS as inference data and (punctured) CSI as inference result data. The UE 100 transmits the CSI to the network apparatus. The network apparatus infers the (punctured) CSI as inference data and infers the CSI obtained using all CSI-RSs (that is, unpunctured CSI) as inference result data.

Even in the case of the two-sided model, the network apparatus transfers an AI/ML model (step S26). In this case, the network apparatus transmits, as a transfer target, the trained AI/ML model used in the UE 100, among two-sided models, to the UE 100. As described above, even in the case of the two-sided model, the present embodiment can be implemented as in the first embodiment (FIG. 16).

### Another Operation Example 2 According to First Embodiment

In the first embodiment, the example in which the trained AI/ML model is transmitted to the UE 100 in the proactive model transfer has been described. For example, the transfer of the trained AI/ML model may be performed in a reactive model transfer. For example, the transfer of the trained AI/ML model is not performed at the timing of step S26, but is performed after step S27.

### Other Embodiments

In the first embodiment described above, supervised learning has mainly been described, while not limited thereto. For example, the first embodiment may be applied to unsupervised learning or reinforcement learning.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each processing operation performed by the UE 100, the gNB 200, or the network apparatus may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing each processing operation performed by the UE 100, the gNB 200, or the network apparatus may be integrated, and at least some of the UE 100, the gNB 200, or the network apparatus may be configured as a semiconductor integrated circuit (chipset or System-on-a-Chip (SoC)).

The functions achieved by the UE 100, the gNB 200, or the network apparatus may be implemented in a circuitry or a processing circuitry programmed to achieve the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### SUPPLEMENTARY NOTES

### Supplementary Note 1

A communication control method in a mobile communication system, the communication control method including:
transmitting, by a network apparatus to a user equipment in an RRC idle state or an RRC inactive state, AI/ML model use information indicating an AI/ML model to be used at the user equipment when congestion occurs; and
transmitting, by the user equipment to the network apparatus, AI/ML model holding information indicating an AI/ML model held by the user equipment when the user equipment is in an RRC connected state in response to reception of the AI/ML model use information.

### Supplementary Note 2

The communication control method described in supplementary note 1, in which the AI/ML model use information includes at least any of identification information of the AI/ML model to be used at the user equipment and a function name of the AI/ML model.

### Supplementary Note 3

The communication control method described in supplementary note 1 or 2, in which the AI/ML model use information includes any of a use start date and time of the AI/ML model to be used at the user equipment, information indicating whether to perform mandatory download of the AI/ML model or to perform optional download of the AI/ML model, and a transmission request for transmitting identification information of a cell on which the user equipment is camping to the network apparatus at a regular time interval.

### Supplementary Note 4

The communication control method described in any one of supplementary notes 1 to 3, in which the AI/ML model holding information includes at least any of identification information of the AI/ML model held at the user equipment and a function name of the AI/ML model.

### Supplementary Note 5

The communication control method described in any one of supplementary notes 1 to 4, further including transmitting, by the network apparatus to the user equipment, an AI/ML model not held by the user equipment before congestion occurs in response to reception of the AI/ML model holding information.

### Supplementary Note 6

A user equipment in a mobile communication system, the user equipment including:
a receiver configured to, when the user equipment is in an RRC idle state or an RRC inactive state, receives AI/ML model use information indicating an AI/ML model to be used when congestion occurs from a network apparatus, ; and
a transmitter configured to transmit, to the network apparatus, AI/ML model holding information indicating an AI/ML model held by the user equipment when the user equipment is in an RRC connected state in response to reception of the AI/ML model use information.

### REFERENCE SIGNS

1: Mobile communication system
20: 5GC (CN)
100: UE
110: Receiver
120: Transmitter
130: Controller
200: gNB
210: Transmitter
220: Receiver
230: Controller
300: AMF

1. A communication control method in a mobile communication system, the communication control method comprising:
transmitting, by a network apparatus to a user equipment in an RRC idle state or an RRC inactive state, Artificial (AI)/Machine Learning (ML) model use information indicating an AI/ML model to be used at the user equipment when congestion occurs; and
transmitting, by the user equipment to the network apparatus, AI/ML model holding information indicating an AI/ML model held by the user equipment when the user equipment is in an RRC connected state in response to reception of the AI/ML model use information.

2. The communication control method according to claim 1, wherein the AI/ML model use information includes at least any of identification information of the AI/ML model to be used at the user equipment and a function name of the AI/ML model.

3. The communication control method according to claim 2, wherein the AI/ML model use information includes any of a use start date and time of the AI/ML model to be used at the user equipment, information indicating whether to perform mandatory download of the AI/ML model or to perform optional download of the AI/ML model, and a transmission request for transmitting identification information of a cell on which the user equipment is camping to the network apparatus at a regular time interval.

4. The communication control method according to claim 1, wherein the AI/ML model holding information includes at least any of identification information of the AI/ML model held at the user equipment and a function name of the AI/ML model.

5. The communication control method according to claim 1, further comprising transmitting, by the network apparatus to the user equipment, an AI/ML model not held by the user equipment before congestion occurs in response to reception of the AI/ML model holding information.

6. A user equipment in a mobile communication system, the user equipment comprising:
a receiver configured to, when the user equipment is in an RRC idle state or an RRC inactive state, receive AI/ML model use information indicating an AI/ML model to be used when congestion occurs from a network apparatus; and
a transmitter configured to transmit, to the network apparatus, AI/ML model holding information indicating an AI/ML model held by the user equipment when the user equipment is in an RRC connected state in response to reception of the AI/ML model use information.
